(19) United States
(12) Patent Application Publication
(10) Pub. No.: US 2018/0153333 A1
(43) Pub. Date: Jun. 7, 2018

(54) APPARATUS AND METHOD FOR HOMOGENIZING GROUND COFFEE BEANS

(71) Applicants: CRAIG LYN, LOS ANGELES, CA (US); DOUGLAS WEBER, SAN FRANCISCO, CA (US); MICHAEL LYN, HOLLYWOOD, FL (US)

(72) Inventors: CRAIG LYN, LOS ANGELES, CA (US); DOUGLAS WEBER, SAN FRANCISCO, CA (US); MICHAEL LYN, HOLLYWOOD, FL (US)

(73) Assignee: Strategic Exits LLC, LOS ANGELES, CA (US)

(21) Appl. No.: 15/369,801

(22) Filed: Dec. 5, 2016

(51) Int. Cl. A47J 31/44

(52) U.S. Cl. CPC A47J 31/44; A47J 31/4403

(57) ABSTRACT

A device for moving coffee grounds from the coffee grinder into a portafilter or other coffee brewing device without spilling coffee grinds. The device may consist of 3 separate parts—a main body, a plug, and a cap—that fit together such that when shaken or agitated coffee grinds on the inside cannot spill out. This allows for easy homogenization without mess of the grinds before brewing, a process that is becoming more prominent in the industry with the advance of specialty coffee. The device fits onto the lip of a portafilter such that removal of the cap and plug allow all of the homogenized coffee grinds to fall directly into the portafilter basket.

### FIELD OF THE INVENTION

The present disclosure relates generally to preparing ground coffee beans for use in producing café style beverages.

### BACKGROUND

As specialty coffee beverages such as espressos, cappuccinos and lattés increase in popularity, the sophistication of coffee preparation has also advanced. To those skilled in the art of coffee preparation, once novel processes and procedures are now becoming standard practice.

In the preparation of espresso beverages, coffee is usually ground directly into a portafilter, tamped down using a plunger like device, and then affixed to an espresso machine that pumps hot water through the compacted coffee grounds at a predetermined pressure. Instead of grinding directly into a portafilter, sometimes an intermediary vessel such as a cup is used. Using this method allows for the grounds to be stirred, weighed, etc., before being transferred into a portafilter. The stirring process in particular is relevant to this invention.

As coffee is ground and allowed to settle directly into a vessel, denser particles of ground coffee tend to accumulate at the bottom of the volume and the lighter particles at the top. In addition, particles of various sizes of coffee grounds are unevenly distributed within the volume. Brewing a dose of ground coffee, with an un-homogenized particle distribution for espresso, yields undesired results. Channeling—where hot water preferentially flows through a path of low resistance and sprays out of the portafilter without properly brewing the coffee, spritzing—where jets of inadequately brewed coffee sprays from the bottom of the portafilter basket, or sub-optimal tasting coffee can occur.

Those skilled in the art of specialty coffee preparation often choose to redistribute or mix the grounds to homogenize the particle distribution. This process is quickly being adopted as an accepted process for producing higher quality espresso. This invention aims to streamline and improve the intermediary process of redistribution in a separate vessel.

### BRIEF DESCRIPTION OF THE DRAWINGS

Embodiments will now be described with reference to the following drawings, which are provided by way of example, and not limitation.

FIG. 1. is a picture of a conventional portafilter

FIG. 2. is an orthographic view of the vessel with the Cap (FIG. 3a) removed

FIG. 3. is a cross section of the vessel

FIG. 4. is an exploded view of the vessel

FIG. 5. is a cross section of the vessel with magnets

### DETAILED DESCRIPTION

In general, the present disclosure relates to a vessel, which allows for the redistribution or homogenization of particles of ground coffee, and filling of a secondary vessel such as a portafilter. Ground coffee with particles not redistributed or homogenized is referred to as “un-homogenized.”

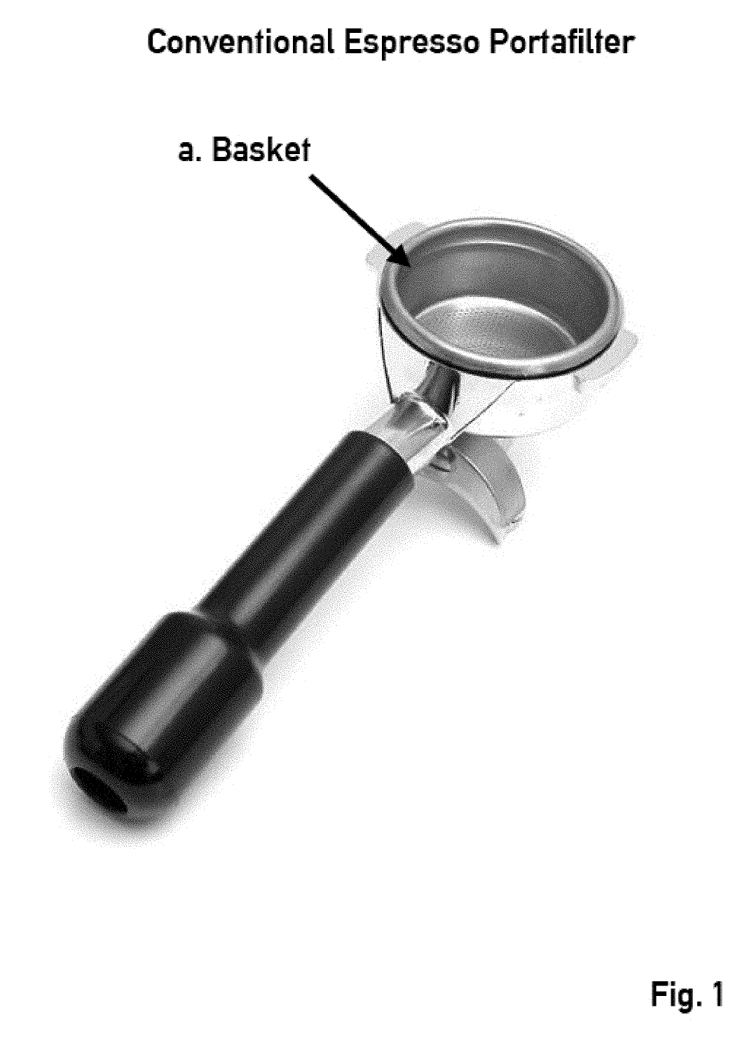

FIG. 1. Illustrates prior art of a conventional espresso portafilter with a Basket (FIG. 1a) wherein ground coffee is deposited before brewing.

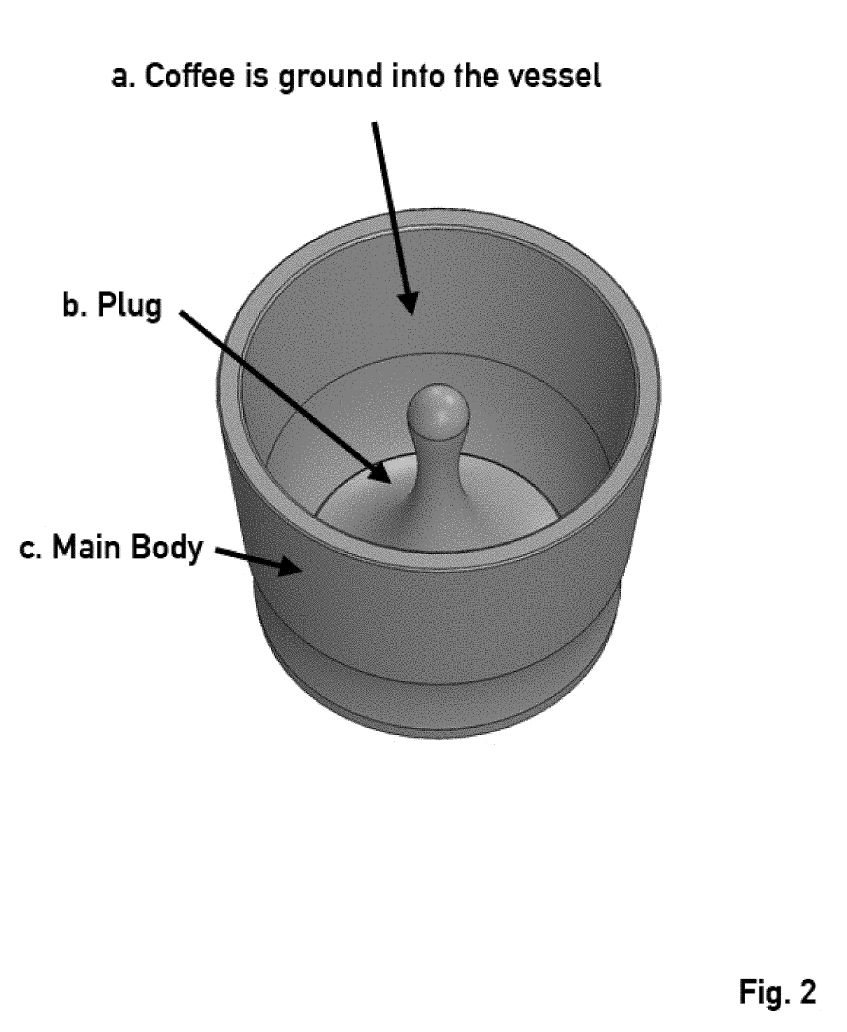

FIG. 2. Illustrates an embodiment of the vessel, wherein the Main Body (FIG. 2c) encloses the Plug (FIG. 2b). Un-homogenized ground coffee is deposited into the vessel (FIG. 2a) with the grounds being retained inside the vessel via the Plug.

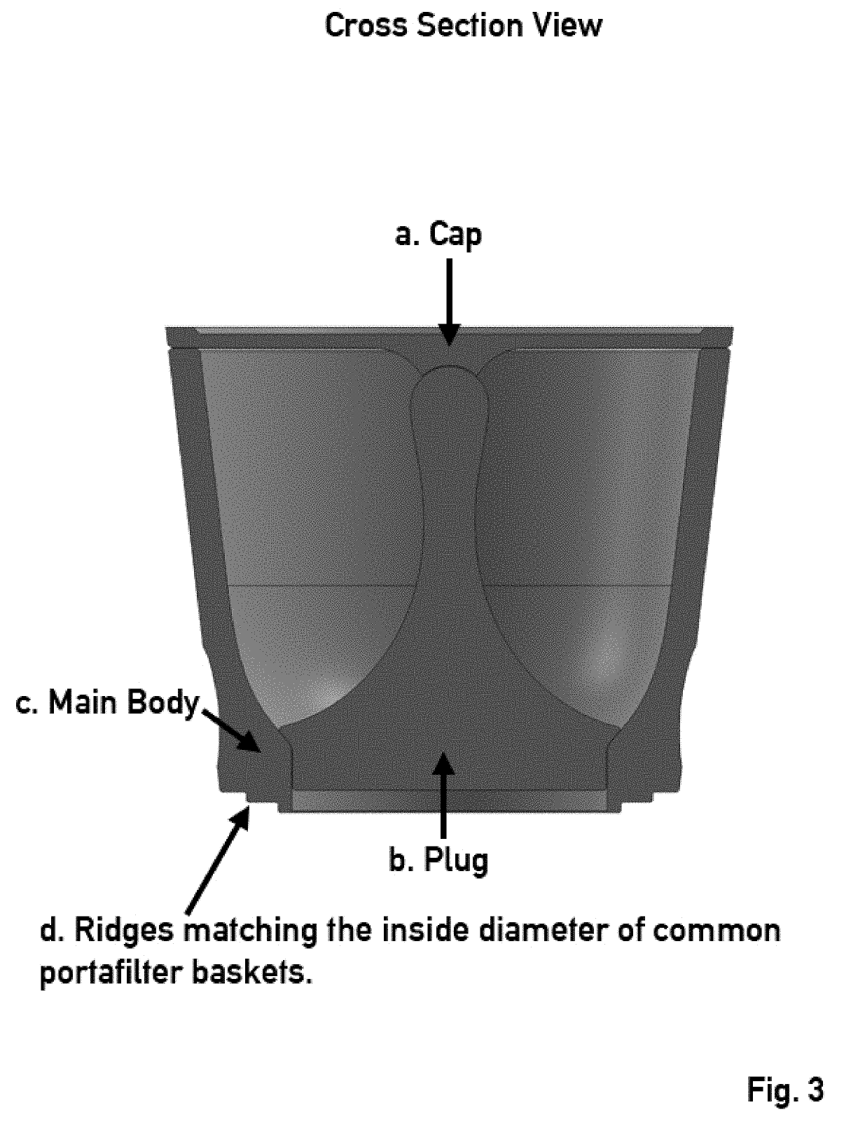

FIG. 3. Illustrates an embodiment of the vessel, wherein the Main Body (FIG. 3c) encloses the Plug (FIG. 3b) and is secured in place via the Cap (FIG. 3a). The chamber within the vessel is filled with un-homogenized coffee grounds. The vessel is shaken or agitated to re-distribute the coffee particles into a homogenized particle distribution.

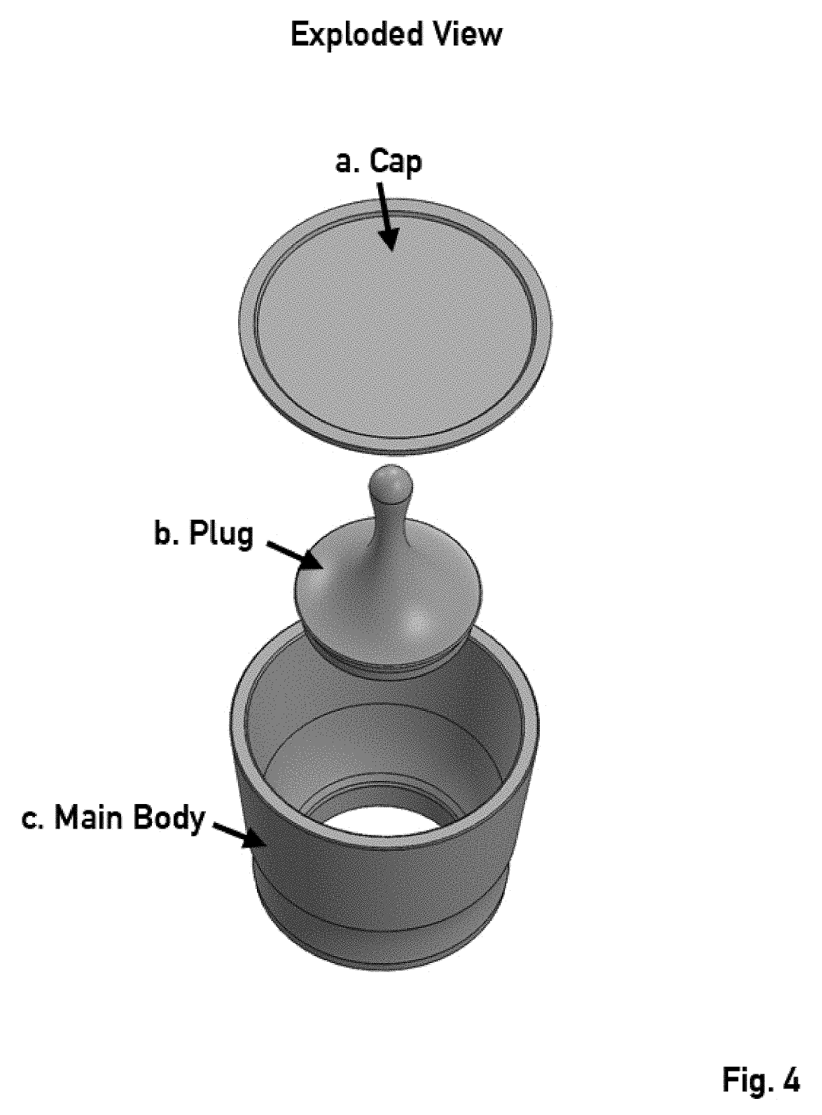

FIG. 4. Illustrates an embodiment of the vessel, wherein the Cap (FIG. 4a) and Plug (FIG. 4b) have been removed from the Main Body (FIG. 4c) to allow the homogenized coffee grounds to be released from the bottom of the vessel. Ridges (FIG. 3d) allow for the vessel to dispense coffee directly into a portafilter basket (FIG. 1a) and remain centered.

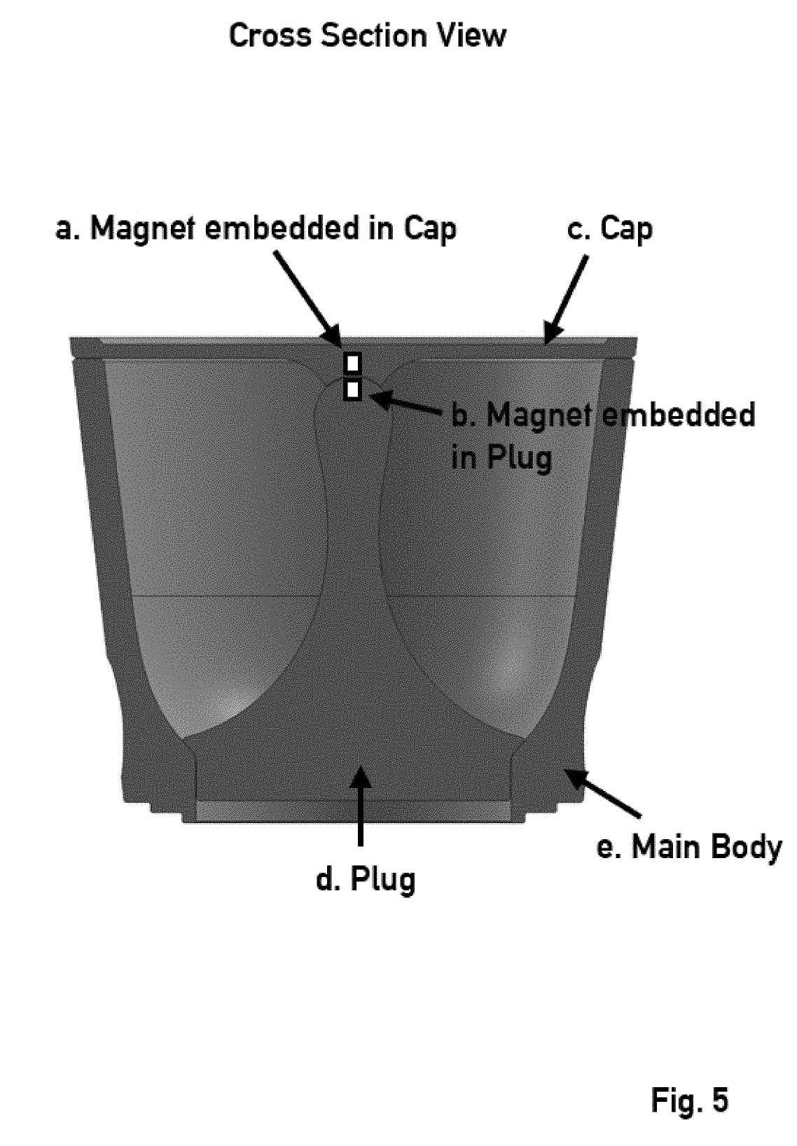

FIG. 5. Illustrates an embodiment of the vessel, wherein a Magnet (FIG. 5a) is embedded in the Cap (FIG. 5c) and a Magnet (FIG. 5b) is embedded in the Plug (FIG. 5d). The Cap and Plug are magnetically coupled; removing the Cap will also remove the Plug from the Main Body (FIG. 5e) reducing the number of steps required to empty the vessel.

We claim:

1. A three-part vessel for homogenizing ground coffee wherein the three parts consist of a:
a. Cap
b. Plug
c. Main Body

2. The aforementioned vessel of claim 1 wherein the Main Body and Cap encloses the Plug when assembled such that coffee is retained when the entire vessel is shaken or agitated.

3. The aforementioned vessel of claim 1 wherein the Plug, when removed, allows the coffee grounds to empty directly into a portafilter or other coffee brewing device.

4. The aforementioned vessel of claim 1 wherein the Main Body has specifically sized ridges to self-center onto the inner diameter of a portafilter basket of a standard size (e.g. 58 mm or 49 mm).

5. The aforementioned vessel of claim 1 wherein the Cap and Plug are magnetically coupled via two or more magnets in close proximity.

6. The embodiment of claim 5 wherein the Cap and Plug are magnetically coupled with a magnet and a ferromagnetic material in close proximity.

7. A multi-part vessel (e.g. 4 or more parts) wherein the individual components serve the same function as the vessel described in claims 1 through 6.
